(19) United States
(12) Patent Application Publication
(10) Pub. No.: US 2016/0126514 A1
(43) Pub. Date: May 5, 2016

(54) BATTERY MODULE

(71) Applicant: HITACHI AUTOMOTIVE SYSTEMS, LTD., Hitachinaka-shi, Ibaraki (JP)

(72) Inventors: Takashi SUZUKI, Hitachinaka-shi (JP); Michihiro KIMURA, Hitachi-shi (JP); Naoki KOJIMA, Hitachinaka-shi (JP)

(73) Assignee: HITACHI AUTOMOTIVE SYSTEMS, LTD., Hitachinaka-shi, Ibaraki (JP)

(21) Appl. No.: 14/897,974

(22) PCT Filed: Jun. 19, 2013
(86) PCT No.: PCT/JP2013/066809

§ 371 Date: Dec. 11, 2015

(51) Int. Cl. H01M 2/10; H01M 10/6557; H01M 10/647; H01M 10/613; H01M 10/625

(52) U.S. Cl. CPC H01M 2/1077; H01M 10/613; H01M 10/625; H01M 10/647; H01M 10/6557; H01M 2220/20

(57) ABSTRACT

The present invention aims to provide a battery module in which adjacent battery cells can be kept in an insulating state while restricting movement of relative positional displacement of the battery cells with a simple configuration.

A battery module (100) according to the present invention is a battery module (100) including a battery block (2) in which a plurality of rectangular battery cells (1) are arranged and laminated, and includes an insulating inter-cell spacer (5) intervening between the plurality of battery cells (1) and double-sided tapes (8) as a pair provided on both surfaces of the inter-cell spacer (5) to respectively fix the paired battery cells (1) adjacent to each other via the inter-cell spacer (5) to the inter-cell spacer (5).

### TECHNICAL FIELD

The present invention relates to a battery module in which a plurality of rectangular battery cells are connected in a laminated state.

### BACKGROUND ART

An electric car or a hybrid car, which uses a motor as a driving source, includes a battery block in which multiple battery cells are connected since the electric car or the hybrid car requires high output. In each battery cell of a lithium ion secondary battery, electrodes expand at the time of charge and discharge, and a distance between a positive-electrode terminal and a negative-electrode terminal is enlarged, which causes an increase in internal resistance and reduction in output. Thus, the expansion needs to be restricted.

Also, the battery cell is constituted by a metallic exterior can, and when the exterior cans having different potentials are electrically connected, short circuit current may flow. Thus, the plurality of battery cells need to be insulated from each other.

For example, known is a structure of a battery block in which a plurality of rectangular battery cells each having a positive-electrode terminal and a negative-electrode terminal on the same surface are directly held by separators, respectively, to keep a mutual insulating state, in which highly rigid end plates as a pair are arranged at both ends in an arranging direction, and in which a distance of the end plates is kept constant in a state in which the end plates are pressed from both of the ends by a coupling and fixing tool (PTL 1).

### CITATION LIST

### Patent Literature

PTL 1: JP 2012-119157 A

### SUMMARY OF INVENTION

### Technical Problem

The separator of the battery block described in PTL 1 has a structure of covering all of the six surfaces of the battery cell to achieve an object of holding the battery cell and keeping the insulating state between the exterior cans of the battery cells and has a problem in which the shape is complicated to make it difficult to reduce manufacturing cost in molding of a plastic made of an insulating material.

Also, since the aforementioned battery block has a structure in which the respective battery cells are supported only by pressing from both of the ends by means of the coupling and fixing tool, the pressing force needs to be strong to restrict movement of relative positional displacement of the individual battery cells caused by vibration, a shock, or the like, which causes a problem in which the separators and the battery cells that can resist the strong pressing force must be set.

In the case of the structure of the aforementioned battery block, the separators and the battery cells cannot resist the strong pressing force, and the pressing force needs to be weakened. Also, when the pressing force is weakened due to the vibration, the shock, or the like, the movement of the relative positional displacement of the battery cells will be restricted only by the plastic spacers. Thus, the restriction depends on strength and dimensional accuracy of the spacers, and it is difficult to restrict the movement of the relative positional displacement of the respective battery cells from the vibration or the shock.

The present invention is accomplished by taking the above respects into consideration, and an object of the present invention is to provide a battery module in which adjacent battery cells can be kept in an insulating state while restricting movement of relative positional displacement of the respective battery cells with a simple configuration.

### Solution to Problem

A battery module of the present invention to achieve the above object includes a battery block in which a plurality of rectangular battery cells are arranged and laminated, including: an insulating inter-cell spacer intervening between the plurality of battery cells; and double-sided tapes as a pair provided on both surfaces of the inter-cell spacer to respectively fix the paired battery cells adjacent to each other via the inter-cell spacer to the inter-cell spacer.

### Advantageous Effects of Invention

According to the present invention, adjacent battery cells can be kept in an insulating state while restricting movement of relative positional displacement of the respective battery cells with a simple configuration. It is to be noted that problems, configurations, and effects other than the aforementioned ones become apparent in the following description of embodiments.

### BRIEF DESCRIPTION OF DRAWINGS

FIG. 1 is an external perspective view of a battery cell.

FIG. 2 is an external perspective view of a battery block.

FIG. 3 is an exploded perspective view of the battery block.

FIG. 4 is a partial cross-sectional view of the battery block.

FIG. 5 is a perspective view of a lower case provided with accessory parts.

FIG. 6 is an exploded perspective view of FIG. 5.

FIG. 7 is a view on arrow in a laminating direction in FIG. 5.

FIG. 8 is a perspective view in which the battery blocks are inserted in the lower case.

FIG. 9 is an exploded perspective view illustrating inserting directions of the battery blocks in FIG. 8.

FIG. 10 is a view on arrow in the laminating direction in FIG. 9.

FIG. 11 is a perspective view illustrating a mounting state of a substrate unit.

FIG. 12 is an exploded perspective view of a battery module.

FIG. 13 is an external perspective view of the battery module.

### DESCRIPTION OF EMBODIMENTS

A battery module according to the present invention has a structure in which a double-sided tape is attached to an inter-cell spacer made of a plastic keeping an insulating state with a battery cell, and in which the battery cells are attached and fixed to each other, to restrict movement of relative positional displacement of the battery cells. To four corners of each battery cell, plastic upper spacers and lower spacers are respectively attached with double-sided tapes. The battery module is assembled by inserting a battery block into a lower case from a side, arranging end plates at both ends, and connecting the lower case with the endplates with screws.

Hereinbelow, an embodiment of a battery module according to the present invention will be described based on the drawings. It is to be noted that the following description is provided, taking as an example an in-vehicle battery module for use in an electric car or a hybrid electric car, and that application thereof is not limited to the in-vehicle battery module.

### (Battery Cell)

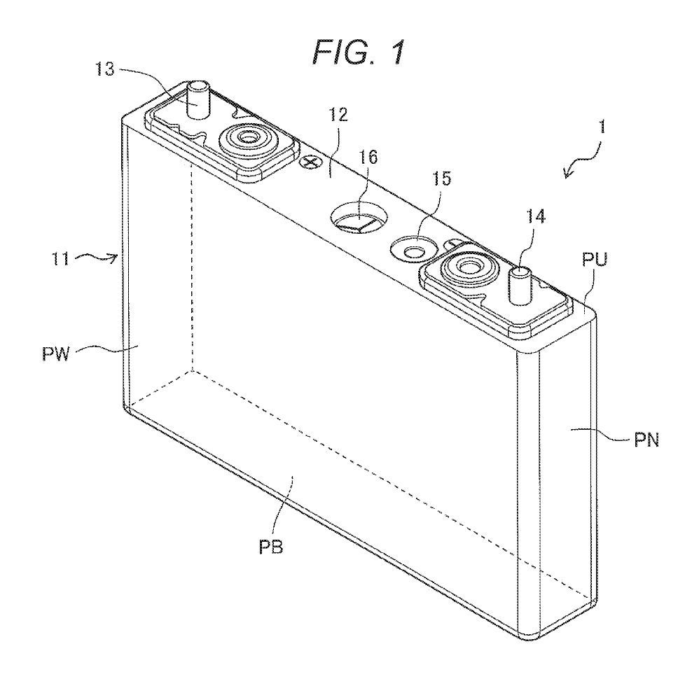

FIG. 1 is an external perspective view of a battery cell.

A battery cell 1 is a rectangular lithium ion secondary battery, in which an electrode group including a positive electrode and a negative electrode as well as non-aqueous electrolyte is housed in a battery container made of an aluminum alloy. The battery container of the battery cell 1 includes a flat box-shaped battery can 11 and a battery lid 12 sealing an opening portion of the battery can 11. The battery can 11 is a flat rectangular container formed by means of deep drawing process and includes a rectangular bottom surface PB, a pair of wide side surfaces PW erecting from long sides of the bottom surface PB, and a pair of narrow side surfaces PN erecting from short sides of the bottom surface PB.

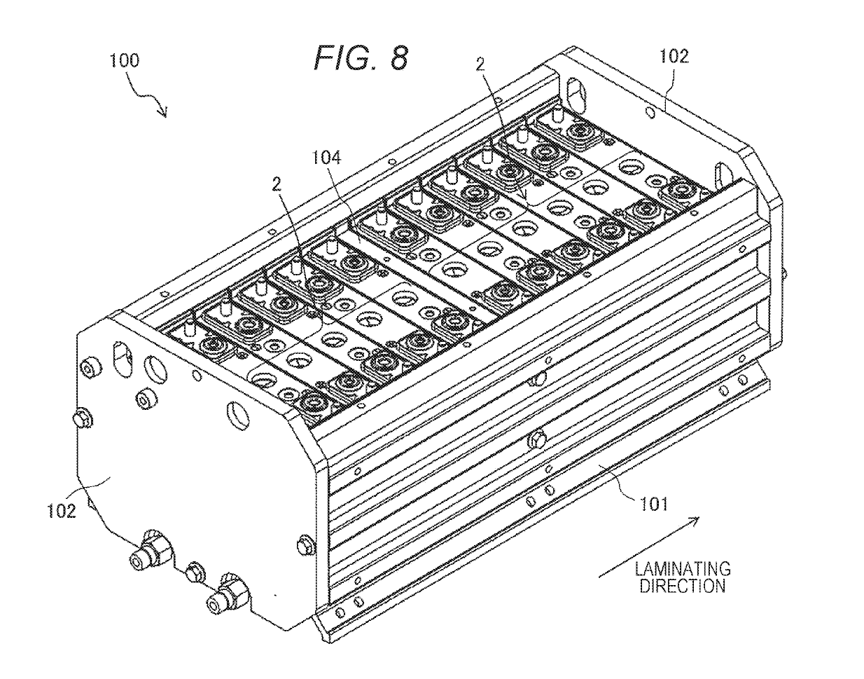

The battery lid 12 is made of a rectangular flat plate member and includes an upper surface PU. The battery lid 12 is provided with a positive-electrode external terminal 13 and a negative-electrode external terminal 14 for voltage input/output. The positive-electrode external terminal 13 and the negative-electrode external terminal 14 are arranged to be away from each other in a direction of a long side of the battery lid 12. From each of the positive-electrode external terminal 13 and the negative-electrode external terminal 14, a bolt for tightening a nut for tightening a bus bar is provided to protrude. The battery lid 12 is laser-welded on the battery can 11 to seal the opening portion of the battery can 11 after the electrode group is housed in the battery can 11. At a middle position in the direction of the long side of the battery lid 12 are provided an inlet 15 for injecting the non-aqueous electrolyte into the battery can 11 and a gas exhaust valve 16 fissuring due to an increase of internal pressure to exhaust gas in the battery container. The plurality of battery cells 1 are arranged and laminated in a thickness direction thereof to constitute a battery block 2 of a battery module 100 (refer to FIG. 8).

### (Battery Block)

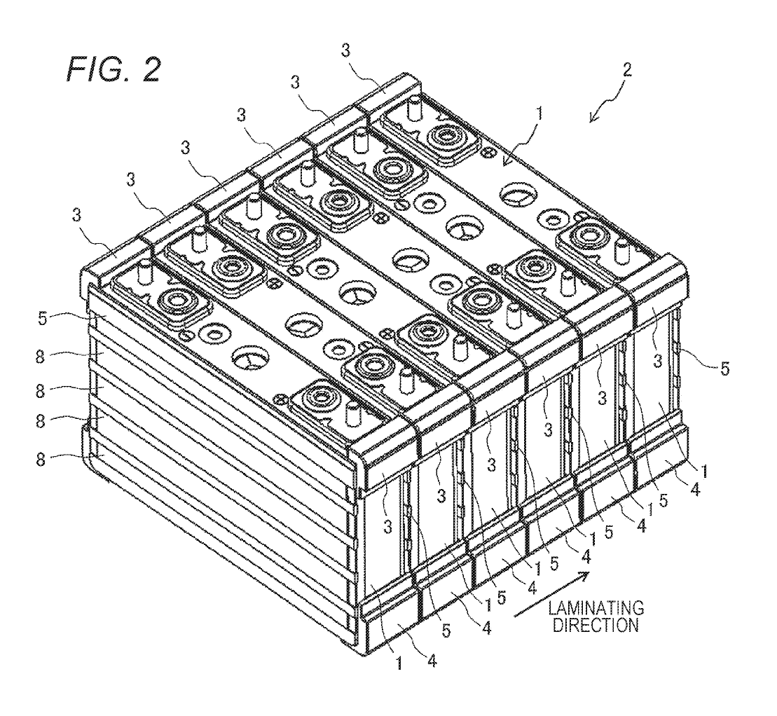

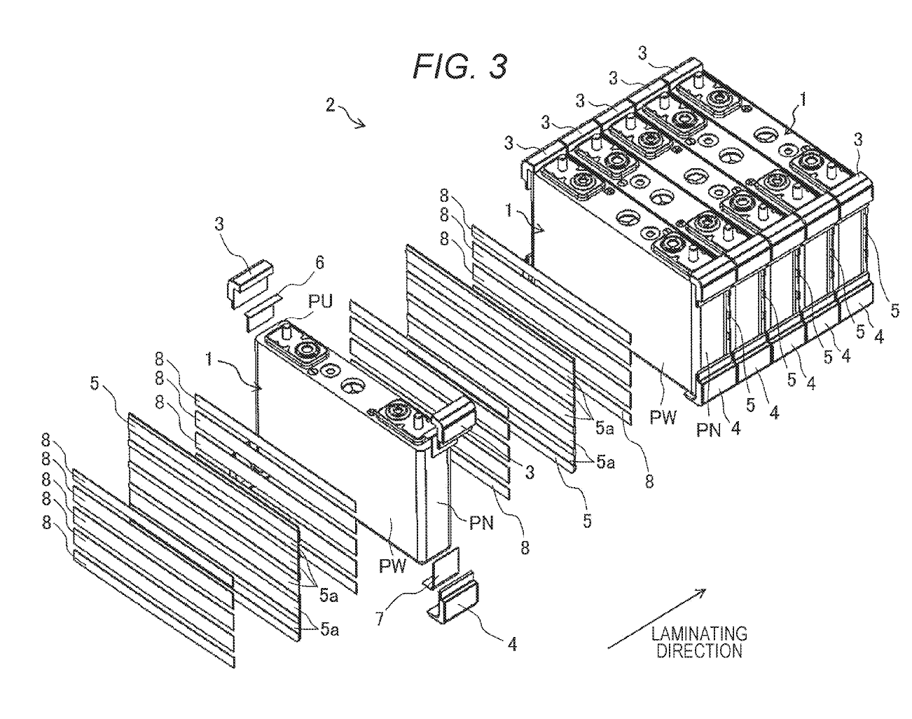

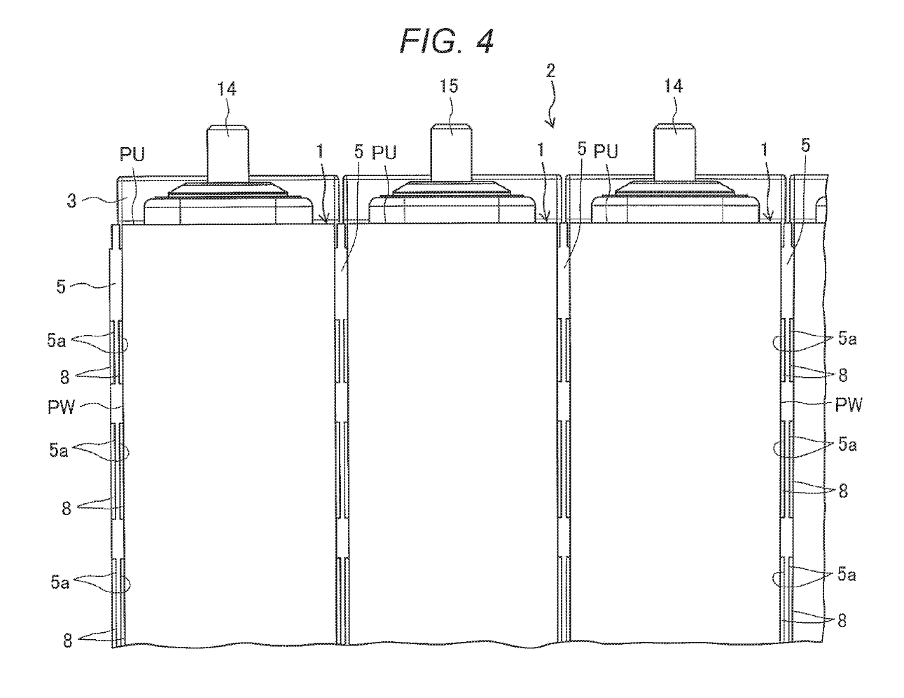

FIG. 2 is an external perspective view of the battery block, FIG. 3 is an exploded perspective view illustrating a state in which the battery block is partially exploded, and FIG. 4 is a partial cross-sectional view of the battery block.

As illustrated in FIGS. 2 and 3, the battery block 2 is configured by arranging and laminating the plurality of battery cells 1. The plurality of battery cells 1 are arranged so that the positive-electrode external terminals 13 and the negative-electrode external terminals 14 may alternately be continuous in a laminating direction. Between the respective battery cells 1, an insulating inter-cell spacer 5 intervenes. The inter-cell spacer 5 is provided on both surfaces thereof with double-sided tapes 8 and attaches and fixes the adjacent battery cells 1 to each other.

That is, the battery block 2 includes the insulating inter-cell spacer 5 intervening between the plurality of battery cells 1 and the double-sided tapes 8 as a pair provided on both surfaces of the inter-cell spacer 5 to respectively fix the paired battery cells 1 adjacent to each other via the inter-cell spacer 5 to the inter-cell spacer 5.

In the battery block 2, since the double-sided tapes 8 are attached to the inter-cell spacer 5 made of a plastic keeping an insulating state with the battery cell 1, and the battery cells 1 are attached to each other with the inter-cell spacer 5 interposed therebetween to fix the mutual positions, movement of relative positional displacement of the battery cells 1 can be restricted.

The inter-cell spacer 5 is formed in a flat plate shape having an approximately equal size to that of the wide side surface PW of the battery cell 1 and is provided on both surfaces thereof with recesses 5a extending over a cell width direction in a groove form. The plurality of recesses 5a are provided at predetermined spaces in a cell height direction. The recesses 5a are provided with the double-sided tapes 8.

In the inter-cell spacer 5, positions of the recesses 5a are set so that, when the battery can 11 expands, the surface of the inter-cell spacer 5 may be exposed at a position enabling the expansion to be restricted efficiently, and the other remaining positions may be provided with the double-sided tapes 8.

Each double-sided tape 8 has a cushioning property enabling the double-sided tape 8 to be compressed in a direction of a tape thickness, is thicker than a depth of the recess 5a of the inter-cell spacer 5, and can be compressed by pressing to a coplanar position to the surface of the inter-cell spacer 5. Accordingly, in a case in which the battery block 2 is compressed in the laminating direction, both of the surfaces of the inter-cell spacer 5 can respectively abut on the wide side surfaces PW of the adjacent battery cells 1 as illustrated in FIG. 4, and the battery cells 1 can be positioned in the laminating direction.

The battery block 2 is provided with an inter-case spacer. The inter-case spacer is an insulating spacer intervening between a case inner wall portion of a below-mentioned block case and the battery block 2 when the battery block 2 is housed in the block case. The inter-case spacer includes a pair of upper spacers 3 and a pair of lower spacers 4.

The pair of upper spacers 3 and the pair of lower spacers 4 are made of an insulating plastic and are arranged to each battery cell 1 at four corners in a direction perpendicular to the laminating direction of the battery cells 1. The upper spacer 3 is disposed at a corner portion between the upper surface PU of the battery lid 12 and the narrow side surface PN of the battery can 11 while the lower spacer 4 is disposed at a corner portion between the bottom surface PB and the narrow side surface PN of the battery can 11.

Each of the upper spacers 3 and the lower spacers 4 has an L-shaped cross-section along each of the four corners of the battery cell 1. Each of the upper spacers 3 and the lower spacers 4 has a length over a thickness direction of the battery cell 1 as the upper spacer 3 illustrated in FIG. 4, for example. The upper spacers 3 and the lower spacers 4 are fixed to the battery cell 1 with double-sided tapes 6 and 7, respectively. Similar to the double-sided tape 8, the double-sided tapes 6 and 7 have a cushioning property enabling the double-sided tapes 6 and 7 to be compressed in the direction of the tape thickness and can absorb a tolerance in the direction perpendicular to the laminating direction when the battery block 2 is housed in the below-mentioned block case.

According to the battery block 2 configured as above, the adjacent battery cells 1 can be kept in an insulating state while restricting movement of relative positional displacement of the respective battery cells 1 with a simple configuration.

The battery block 2 can restrict the movement of the relative positional displacement of the respective battery cells 1 in a state of not applying a pressing force from both sides in the laminating direction as well as in a state of applying a pressing force from both sides in the laminating direction. Since the movement of the positional displacement is restricted, the plurality of battery cells 1 can be carried even without tightening members such as screws and welding and a tightening work, which leads to improvement in assembling workability. Also, since no tightening means such as screws is used in assembling the battery block 2, working man-hour for a tightening work and the like can be reduced, and weight reduction can be achieved due to reduction in the number of parts.

Also, since the inter-cell spacer 5 is simply in a flat plate shape and has a simpler shape than that of a conventional spacer having a structure of covering all of the six surfaces of the battery cell, manufacturing cost in plastic molding can be reduced. Further, as the double-sided tape 8, a general-purpose product having a low unit price can be used, and manufacturing cost can be reduced.

Also, since the inter-cell spacer 5 intervenes, the battery cans 11 of the battery cells 1 can be kept in an insulating state to prevent the battery cans 11 from being electrically connected to each other even in a case in which a large shock enough to deform the battery cans 11 is applied due to a car crash or the like.

In the inter-cell spacer 5, a position of the double-sided tape 8 against the battery cell 1 can be defined by the recess 5a, and the double-sided tape 8 can be attached to a predetermined position accurately all the time, which can simplify an attaching work.

Although the five strip-shaped recesses 5a and double-sided tapes 8 are arranged on the inter-cell spacer 5 in the present embodiment, each shape can be changed to a shape corresponding to the entire surface of the wide side surface PW of the battery cell 1, a circular shape, or the like freely depending on an area to which the double-sided tape 8 is to be attached.

The shape of the inter-cell spacer 5 does not always need to be equal to the cross-sectional shape of the battery cell 1 and can be changed freely to achieve an object of keeping an insulating state between the battery cans 11 of the battery cells 1 and between the positive-electrode external terminal 13 and the negative-electrode external terminal 14.

### (Battery Module)

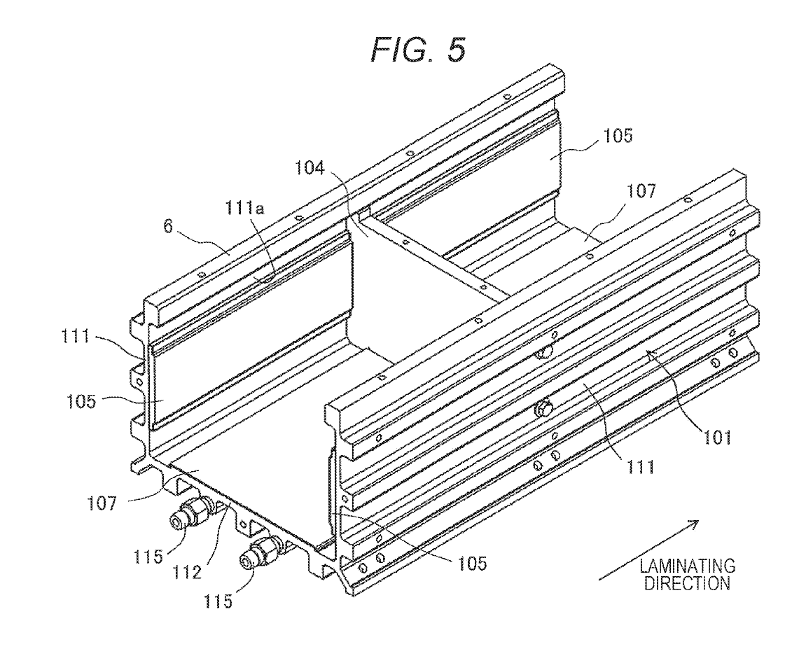

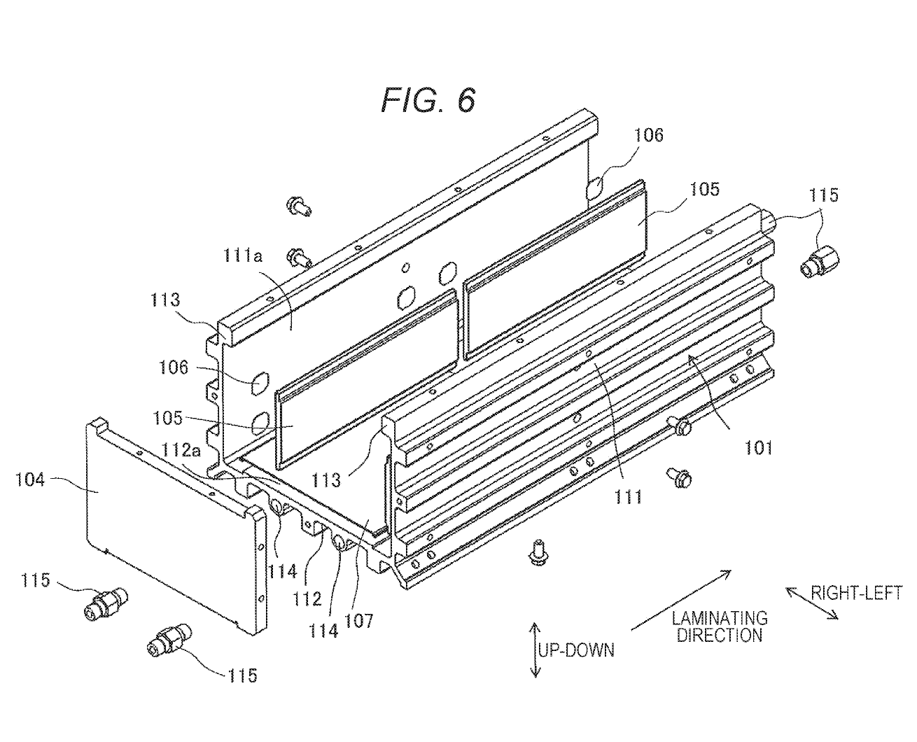

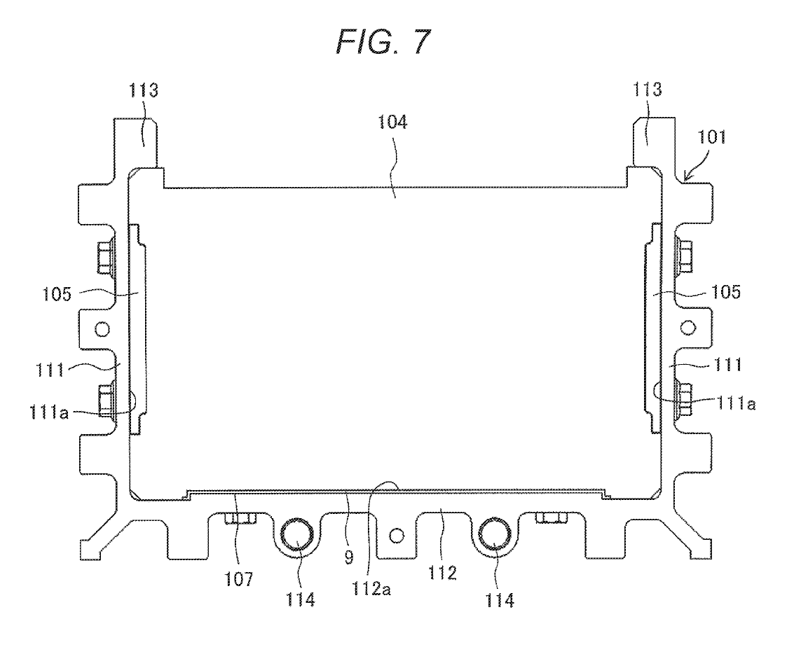

FIG. 5 is a perspective view of the lower case provided with accessory parts, FIG. 6 is an exploded perspective view of FIG. 5, and FIG. 7 is a view on arrow in the laminating direction in FIG. 5.

The aforementioned battery block 2 is housed in a block case. The block case includes a case inner wall portion extending along an inserting direction of the battery block 2 and is configured to enable the battery block 2 to be housed therein by relatively moving and inserting the battery block 2 along the laminating direction of the battery cells 1. In the present embodiment, the block case is configured to house two battery blocks 2.

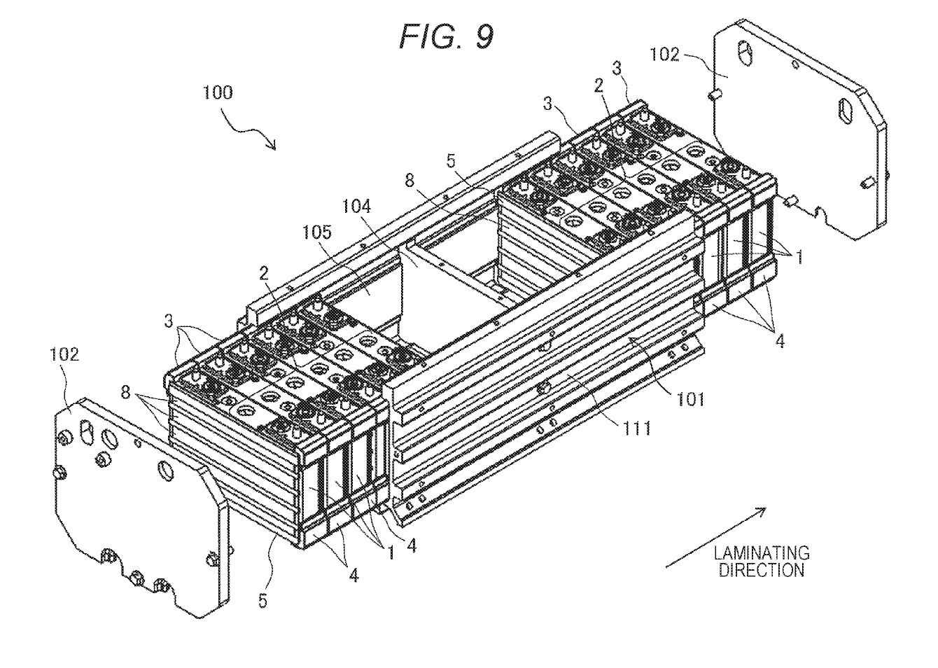

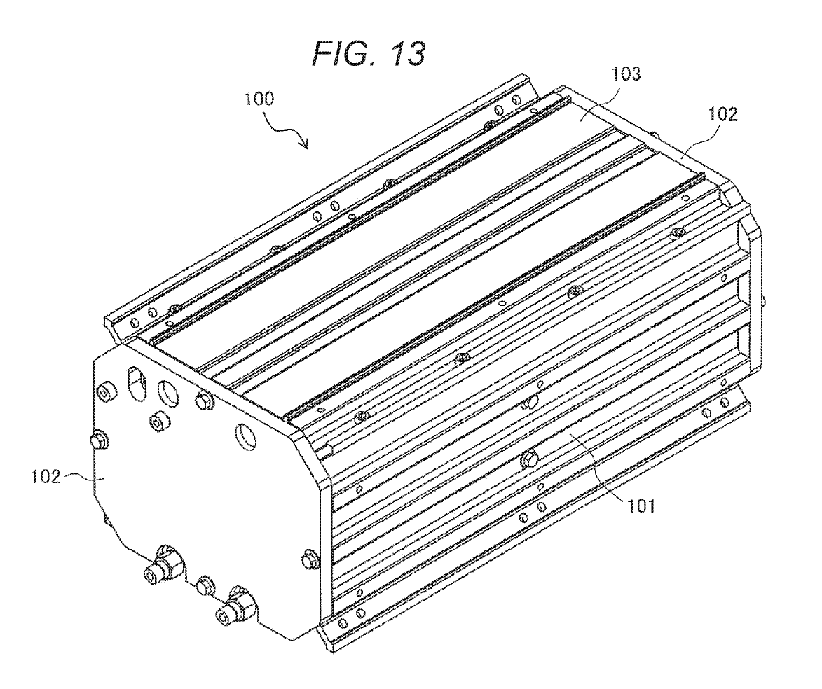

The block case includes a lower case 101, a pair of endplates 102 (refer to FIG. 9), a section plate 104, and an upper plate 103 (refer to FIG. 13). The lower case 101 has a cross-section formed uniformly in the laminating direction and is made of a lightweight material having a low specific heat such as an aluminum alloy by means of extrusion processing or the like. The lower case 101 is provided at a case outer wall portion thereof with a plurality of projection portions to secure a larger surface area for improvement in heat dissipation performance.

The lower case 101 includes, as supporting plates supporting the battery block 2 to enable the battery block 2 to relatively move along the laminating direction, a pair of side plates 111 extending in parallel with each other and a lower plate 112 connecting lower ends of the paired side plates 111, and has a cross-section formed approximately in a U shape.

Each of the paired side plates 111 includes an opposed surface 111a opposed to the narrow side surface PN of the battery cell 1 while the lower plate 112 includes an opposed surface 112a opposed to the bottom surface PB of the battery cell 1, and these opposed surfaces 111a and 112a constitute the case inner wall portion. The paired side plates 111 include protrusion portions 113 protruding from upper end portions in directions of approaching to each other and opposed to the upper surface PU of the battery cell 1.

The lower case 101 is provided with a cooling flow path extending along the laminating direction and circulating a refrigerant. The cooling flow path is formed by a through hole 114 penetrating the lower plate 112 of the lower case 101 along the laminating direction. Each end of the through hole 114 is provided with a female screw to allow a piping joint 115 to be attached thereto.

The section plate 104 is interposed between the plurality of battery blocks housed in the block case and sections the battery blocks 2. The section plate 104 is inserted into the lower case 101 from one side in the laminating direction and is fixed to the pair of side plates 111 and the lower plate 112 by tightening screws in three directions of both sides and a lower side.

To the opposed surface 111a of the sideplate 111, an insulating plate 105 is attached. The insulating plate 105 is made of an insulating plastic and is fixed to the side plate 111 with a double-sided tape 106. The insulating plate 105 intervenes between the narrow side surface PN of the battery cell 1 and the side plate 111 to insulate the narrow side surface PN from the side plate 111 and can be kept in an insulating state to prevent the side plate 111 of the lowercase 101 from being electrically connected to the battery cell 1 even in a case in which a large shock enough to deform the battery module 100 is applied due to a car crash or the like.

To the opposed surface 112a of the lower plate 112, a heat transfer sheet 107 is attached. The heat transfer sheet 107 abuts on the bottom surface PB of the battery cell 1 to enable heat of the battery cell 1 to be transferred to the lower plate 112. The insulating plates 105 and the heat transfer sheets 107 are separate and independent from each other with the section plate 104 as a boundary and are provided in respective sections sectioned by the section plate 104. The lower case 101 is provided with a plurality of mounting holes for mounting the battery module 100 on a car.

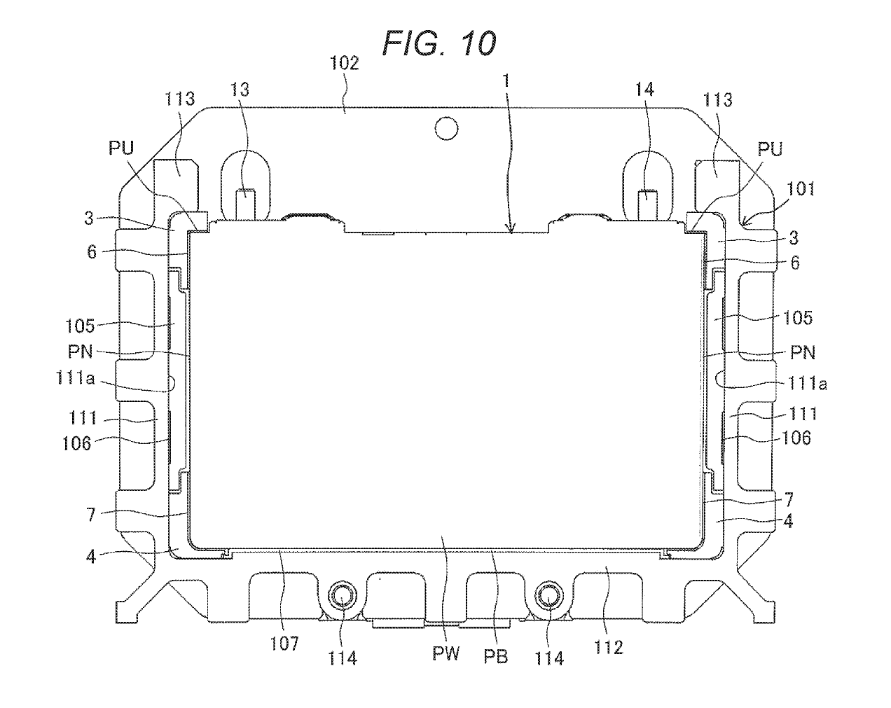

FIG. 8 is a perspective view in which the battery blocks are inserted in the lower case, FIG. 9 is an exploded perspective view illustrating the inserting directions of the battery blocks 2 in FIG. 8, and FIG. 10 is a view on arrow in the laminating direction in FIG. 9.

The battery block 2 is inserted from an end portion of the lower case 101 in the laminating direction in a state in which the lower case 101 is provided with the accessory parts. In the present embodiment, the two battery blocks 2 are moved and inserted from both sides of the lower case 101 in the laminating direction with the section plate 104 as a boundary in directions of approaching to each other as illustrated in FIG. 9.

The battery block 2 is supported by the pair of side plates 111 and the lower plate 112 of the lower case 101 and is moved along the laminating direction of the battery cells 1. As illustrated in FIG. 10, in the lower case 101, the paired upper spacers 3 abut on corner portions between the opposed surfaces 111a of the side plates 111 and the protrusion portions 113, and the paired lower spacers 4 abut on corner portions between the side plates 111 and the lower plate 112, movement of the battery block 2 in the direction perpendicular to the laminating direction is restricted, and the battery block 2 is moved only in the laminating direction.

At the time of insertion of the battery block 2, a dimensional tolerance of the battery block 2 and a dimensional tolerance of the lower case 101 in the direction perpendicular to the laminating direction are absorbed by the cushioning property of the double-sided tapes 6 and 7 of the upper spacers 3 and the lower spacers 4.

By selecting a slidable material against the lower case 101 as a material for the upper spacer 3 and the lower spacer 4 and selecting a slidable material against the battery block as a material for the heat transfer sheet 107, the battery block 2 can be inserted into the lower case 101 smoothly.

After insertion of the battery blocks 2, the end plates 102 are arranged at both ends of the lower case 101 and are fixed to the lower case 101 by tightening screws. The battery blocks 2 are fixed in a state of being pressed by the end plates 102 in the laminating direction. Stress in a tensile direction acts on a tightening bolt connecting the end plates 102 with the lower case 101. After insertion, the bottom surface PB of the battery cell 1 and the lower case 101 are in a thermal coupling state via the heat transfer sheet 107.

According to the aforementioned battery module 100, the rectangle of the battery cell 1 is fixed to the lower case 101 via the upper spacers 3 and the lower spacers 4 to cause the position thereof to be regulated, and the respective battery cells 1 constituting the battery block 2 and the lower case 101 are integrated, as illustrated in the cross-sectional view of FIG. 10. Accordingly, movement of the battery cells 1 can be restricted from vibration or a shock of the car.

Also, since the lower case 101 is provided with the through hole 114 to form the cooling flow path, a member such as a pipe required as the cooling flow path and a member such as a plate for heat exchange are dispensed with, which can achieve weight reduction of the module and reduction in the number of parts. Also, the lower case 101 is provided at the case outer wall portion thereof with the projection portions, has a larger surface area than that of a simple plate shape, and is excellent in heat exchange efficiency.

Also, since the lower case 101 has the structure in which the battery block 2 is movable in the laminating direction therein, load in the laminating direction applied by the end plates 102 can reliably be transmitted only to the battery cells 1, and load to be applied to each of the plurality of battery cells 1 can be uniform. Also, the stress in the tensile direction can act on the tightening bolt connecting the end plates 102 with the lower case 101, and durability of the tightening bolt can be improved further than in a case in which shear stress acts.

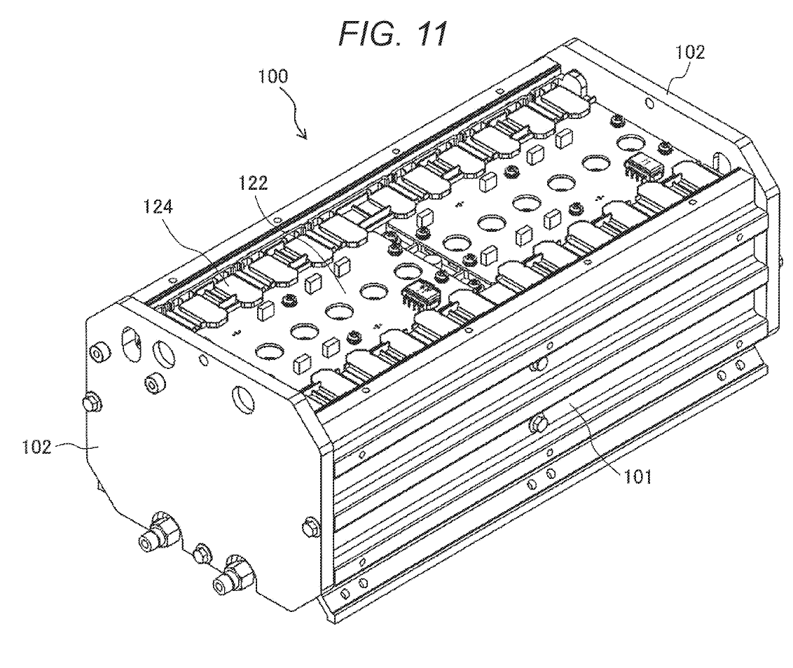

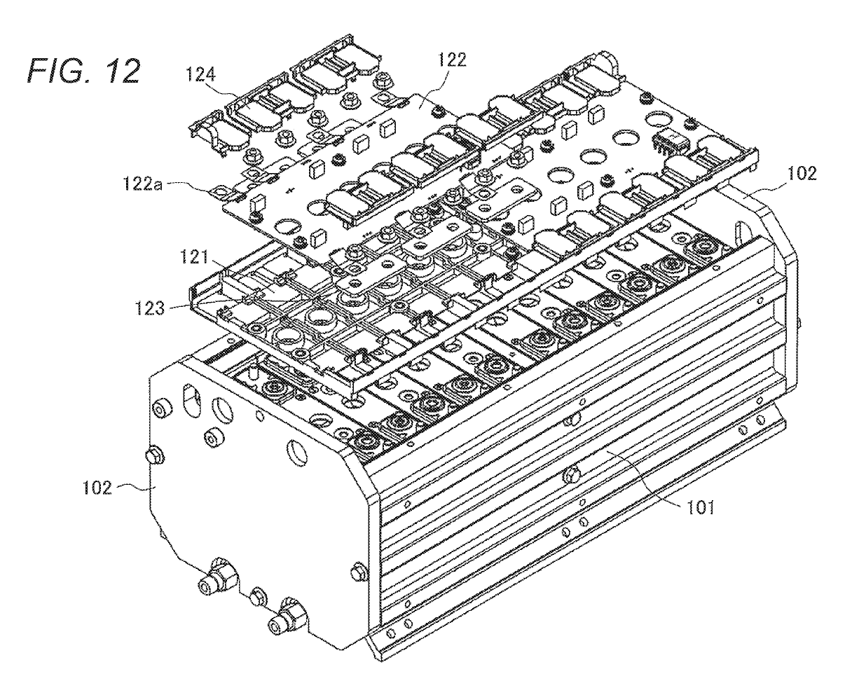

FIG. 11 is a perspective view illustrating a mounting state of a substrate unit, and FIG. 12 is an exploded perspective view of the battery module.

The positive-electrode external terminals 13 and the negative-electrode external terminals 14 of the adjacent battery cells 1 are electrically connected by a plurality of bus bars 123. Each bus bar 123 is connected to a substrate connecting terminal 122a of a substrate unit 122. The substrate unit 122 includes circuits measuring voltage of the respective battery cells 1, connectors, and fuses. On an upper side of the substrate unit 122 in the battery cell height direction are provided insulating caps 124 fitted with insulating covers 121 and covering the terminals of the respective battery cells 1.

FIG. 13 is a perspective view illustrating a state in which the lower case 101 has been provided with the upper plate 103. The battery module 100 is completed by covering the lower case 101 with the upper plate 103 and tightening screws.

The embodiments of the present invention have been described above, and the present invention is not limited to the foregoing embodiments and can be altered in terms of design in various ways without departing from the spirit of the present invention described in the patent claims. For example, the foregoing embodiments have been described in detail to facilitate understanding of the present invention, and the present invention is not limited to one including all of the components described herein. Also, some components of one embodiment can be substituted with components of another embodiment, and components of another embodiment can be added to components of one embodiment. Further, some components of each embodiment can be added, deleted, and substituted with other components.

### REFERENCE SIGNS LIST

1 battery cell

2 battery block

3 upper spacer

4 lower spacer

5 inter-cell spacer

11 battery can

12 battery lid

13 positive-electrode external terminal

14 negative-electrode external terminal

15 inlet

100 battery module

101 lower case

102 end plate

103 upper case

104 section plate

105 side plate

107 heat transfer sheet

115 piping joint

121 insulating cover

122 substrate unit

122a substrate connecting terminal

123 bus bar

124 insulating cap

1. A battery module including a battery block in which a plurality of rectangular battery cells are arranged and laminated, comprising:
an insulating inter-cell spacer intervening between the plurality of battery cells; and
double-sided tapes as a pair provided on both surfaces of the inter-cell spacer to respectively fix the paired battery cells adjacent to each other via the inter-cell spacer to the inter-cell spacer.

2. The battery module according to claim 1, wherein
the inter-cell spacer has a recess on each of both of the surfaces of the inter-cell spacer, and
the double-sided tape is provided in the recess.

3. The battery module according to claim 2, further comprising:
a block case enabling the battery block to be housed therein by relatively moving and inserting the battery block along a laminating direction of the battery cells;
an insulating inter-case spacer intervening between a case inner wall portion of the block case extending along an inserting direction of the battery block and the battery block; and
a double-sided tape fixing the inter-case spacer to the battery cell of the battery block.

4. The battery module according to claim 3, wherein the block case includes:
a supporting plate supporting the battery block to enable the battery block to relatively move along the laminating direction of the battery cells; and
a pair of end plates respectively connected with both end portions of the supporting plate and keeping the battery block in a state of being pressed in the laminating direction of the battery cells.

5. The battery module according to claim 4, wherein the supporting plate includes a cooling flow path extending along the laminating direction of the battery cells and circulating a refrigerant.

6. The battery module according to claim 3, wherein the inter-case spacer includes a pair of upper spacers and a pair of lower spacers arranged to each battery cell at four corners in a direction perpendicular to the laminating direction of the battery cells.
